(19) United States
(12) Patent Application Publication
(10) Pub. No.: US 2021/0161161 A1
(43) Pub. Date: Jun. 3, 2021

(54) SYSTEMS AND METHODS FOR DISINFECTING MEAT PRODUCTS

(71) Applicant: Preservation Tech LLC, Hull, IA (US)

(72) Inventors: Kevin York, Joplin, MO (US); Jimmy Moler, Hull, IA (US); Sannel Patel, Hull, IA (US); Joe Rheingans, Hull, IA (US); Joel Beukelman, Hull, IA (US); Tod Cunningham, Hull, IA (US); Christopher McCoy, Hull, IA (US); Andy Shea, Hull, IA (US); Tyler Broich, Hull, IA (US)

(21) Appl. No.: 17/110,038

(22) Filed: Dec. 2, 2020

Related U.S. Application Data
(60) Provisional application No. 62/942,327, filed on Dec. 2, 2019.

(51) Int. Cl. A23B 4/16; A23B 4/12; A23L 3/3445; A23L 3/3499

(52) U.S. Cl. CPC A23B 4/16; A23B 4/12; A23V 2002/00; A23L 3/3499; A23L 3/3445

(57) ABSTRACT

Disclosed is a method for disinfecting a meat product by placing the meat in a contacting chamber and directly contacting the meat with gaseous ozone for a time interval sufficient to substantially reduce pathogens on the meat. In certain aspects, the time interval is from about 3 seconds to about 30 seconds. In further aspects, the time interval is from about 5 seconds to about 15 seconds. In yet further aspects, the time interval is about 5 seconds. In certain implementations, the gaseous ozone is introduced into the chamber at about 10 liters per minute. In further implementations, the gaseous ozone is from about 6% to about 8% ozone.

### CROSS-REFERENCE TO RELATED APPLICATION(S)

This application claims priority to U.S. Provisional Application No. 62/942,327 filed April Dec. 2, 2019 and entitled “SYSTEMS AND METHODS FOR DISINFECTING MEAT PRODUCTS,” which is hereby incorporated by reference in its entirety under 35 U.S.C. § 119(e).

### TECHNICAL FIELD

The disclosed technology relates generally to systems and method for disinfecting meat products.

### BACKGROUND

As poultry processing facilities are continually looking for alternative technologies that balance cost versus result, further evaluations of different biocides having different molecular structures and different modes of action has become of significant interest. Alternative disinfection methods have become a part of any corporation's social responsibility plan to lower the environmental impact that harsh antimicrobials potential pose. In addition, the production of safe, healthy food requires that organizations pursue alternative means to lower the risk of food borne organisms why providing a safe environment for their employees. Peracetic acid (PAA) has become a reliable yet versatile antimicrobial in the defense of safe food production; however, more tools are needed that provide an added layer of protection in lowering the risk of naturally occurring pathogenic organisms. Thus, there is a need in the art for improved biocides, that can be applied safely and economically.

### BRIEF SUMMARY

Disclosed herein is a method for disinfecting a meat product by placing the meat in a contacting chamber and directly contacting the meat with gaseous ozone for a time interval sufficient to substantially reduce pathogens on the meat. In certain aspects, the time interval is from about 3 seconds to about 30 seconds. In further aspects, the time interval is from about 5 seconds to about 15 seconds. In yet further aspects, the time interval is about 5 seconds.

In certain implementations, the gaseous ozone is introduced into the chamber at about 10 liters per minute. In further implementations, the gaseous ozone is from about 6% to about 8% ozone.

According to further implementations, there is negative pressure in the contacting chamber.

In further implementations, the method further comprises treating the meat product with a liquid disinfectant, prior to introducing the meat product into the contacting chamber. In certain aspects, the liquid disinfectant is peracetic acid (PAA).

In certain aspects, the meat product treated by the disclosed method is chosen from poultry, beef, lamb, and pork. In certain implementations, the meat product is poultry. In exemplary implementations, the poultry is chicken.

While multiple embodiments are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 shows pathogen count data, according to certain embodiments.

FIG. 2 shows pathogen count data, according to certain embodiments.

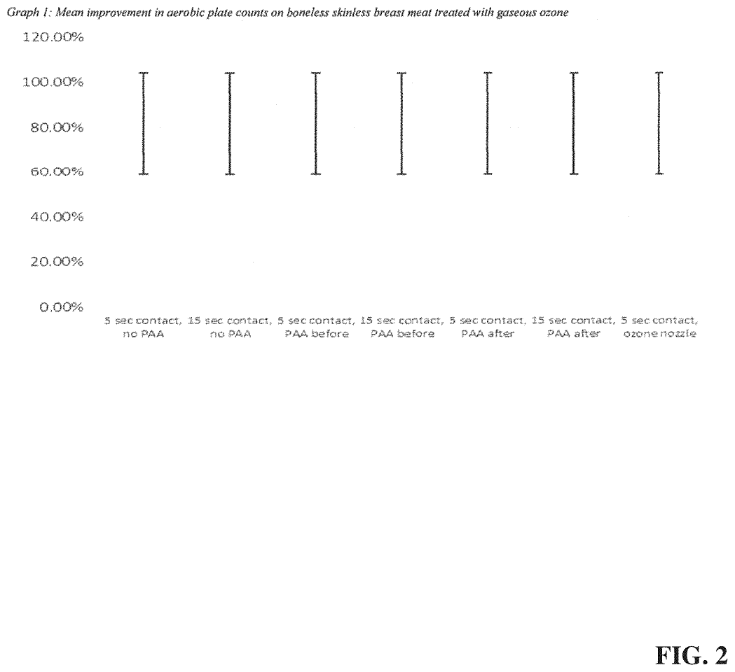

FIG. 3 shows pathogen count data, according to certain embodiments.

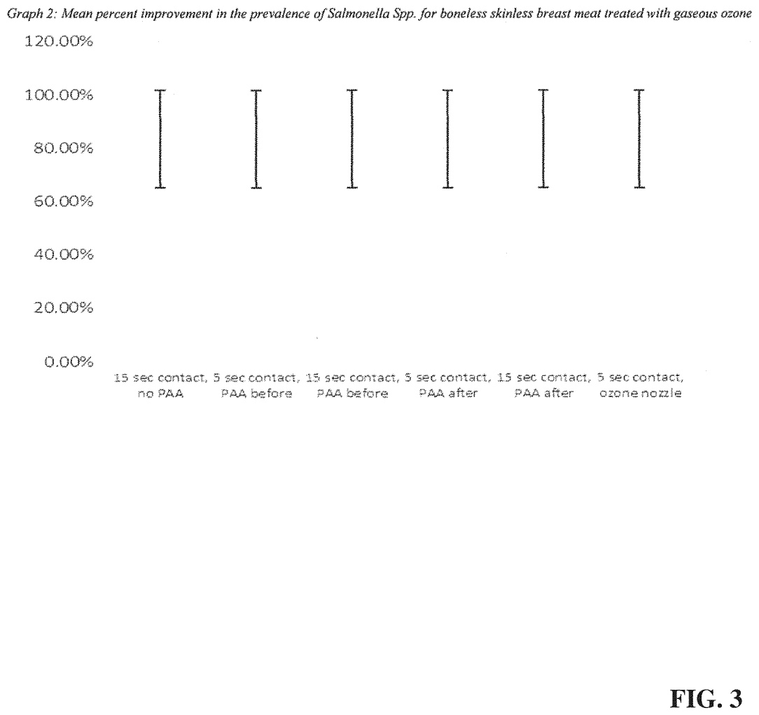

FIG. 4 shows pathogen count data, according to certain embodiments.

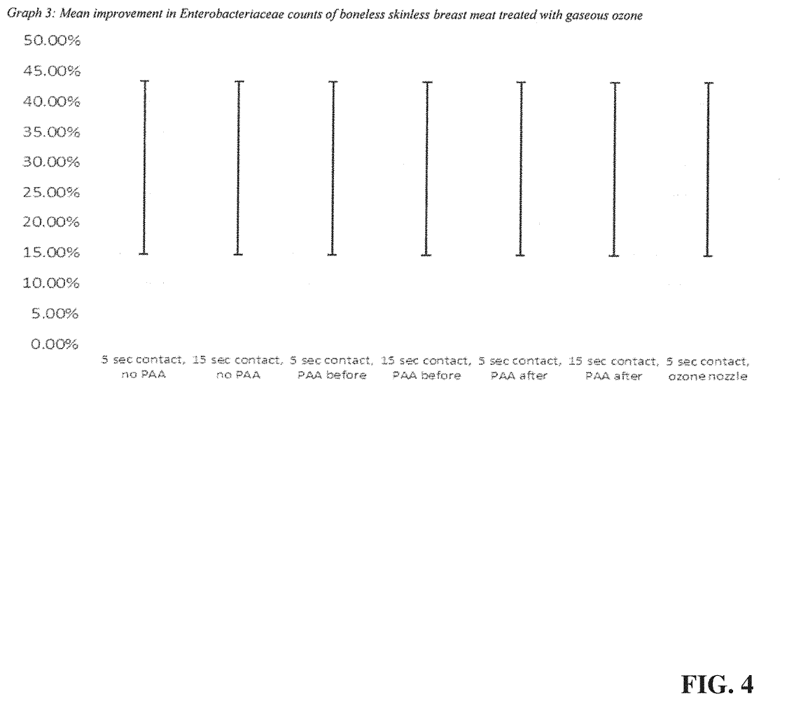

FIG. 5 shows pathogen count data, according to certain embodiments.

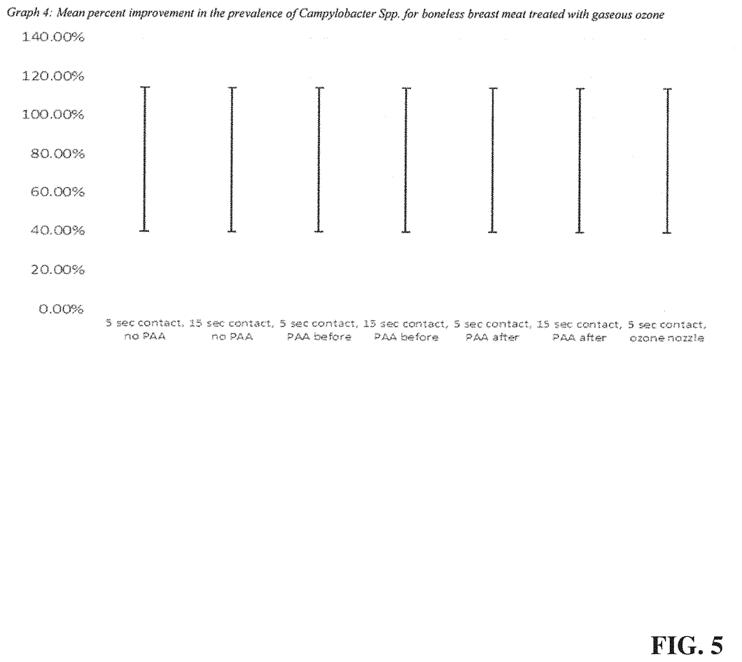

FIG. 6 is an exemplary photographic image of the contacting chamber, according to certain embodiments.

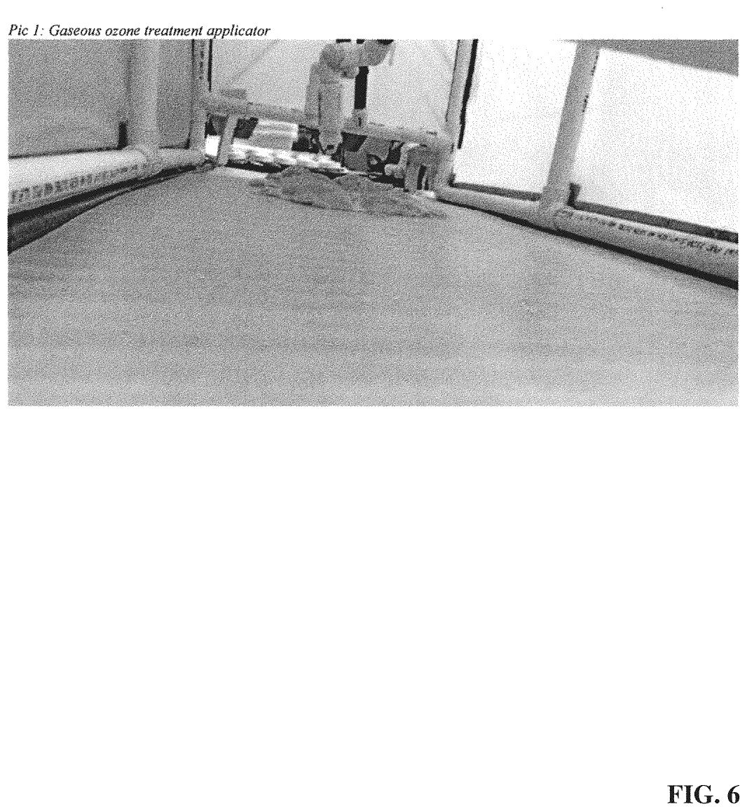

### DETAILED DESCRIPTION

Ranges can be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of pathogens would either completely lack pathogens, or so nearly completely lack pathogens that the effect would be the same as if it completely lacked pathogens. In other words, a composition that is “substantially free of an ingredient or element may still actually contain such item as long as there is no measurable effect thereof.

Ozone, a gas that is a triatomic form of oxygen, has been used for years in applications such as treatment of municipal water and bottled water. Ozone is a broad-spectrum biocide against viruses, bacteria, biofilms, fungi and protozoa—none of which can build up a resistive tolerance to ozone because ozone disinfects by oxidation processes. Ozone does not act as a systemic poison to microorganisms, but rather, destroys them by oxidation consequently making it impossible for a microorganism to build up any resistance to oxidation.

Disclosed herein is a method for disinfecting a meat product by placing the meat product in a contacting chamber and directly contacting the meat with gaseous ozone for a time interval, wherein the time interval is sufficient to substantially reduce pathogens on the meat. In certain implementations, the time interval is sufficient to produce meat that is substantially free of pathogens.

In certain aspects, time interval is from about 3 seconds to about 30 seconds. In further aspects, the time interval is from about 5 seconds to about 15 seconds. In yet further aspects, the time interval is about 5 seconds.

According to certain embodiments, the gaseous ozone is introduced into the chamber at about 10 liters per minute. In further aspects, the gaseous ozone is comprised of from about 6% to about 8% ozone.

According to certain embodiments, the pressure in the contacting chamber is lower than ambient pressure e.g., there is a negative pressure in the contacting chamber. In certain implementations, the negative pressure in the chamber from about 0 to about 3 psi. In further implementations, the negative pressure in the chamber is about 3 psi.

According to further embodiments, the method further comprises treating the meat product with a liquid disinfectant, prior to introducing the meat product into the contacting chamber. In exemplary aspects, of these embodiments, the liquid disinfectant is peracetic acid (PAA).

As will be appreciated by a person skilled in the art, the disclosed method may be utilized with meat from In certain aspects, the meat product is chosen from poultry, beef, lamb, and pork. In further aspects, the meat product is a combination of the foregoing. According to further aspects, the meat product is poultry. In exemplary implementations, the poultry is chicken.

The meat products can be in a variety of forms, including meat cuts and ground meat (for example, ground beef). Examples of meat cuts include primal cuts, subprimal cuts and retail cuts. Primal cuts include beef loins, pork loins, beef ribs, pork hams, and beef rounds. Subprimal cuts include beef strips, beef rib eyes, beef top sirloins, pork shoulder butts, pork center cut loins, pork sirloins, and beef bottom round flats. Retail cuts include sirloin steaks, stew meat, cube steaks, country style ribs, pork chops, blade steaks, cutlets, poultry thighs, poultry breasts, and poultry tenders.

### EXPERIMENTAL EXAMPLES

The following examples are put forth so as to provide those of ordinary skill in the art with a complete disclosure and description of how the articles, devices and/or methods claimed herein are made and evaluated, and are intended to be purely exemplary of the invention and are not intended to limit the scope of what the inventors regard as their invention. However, those of skill in the art should, in light of the present disclosure, appreciate that many changes can be made in the specific embodiments which are disclosed and still obtain a like or similar result without departing from the spirit and scope of the invention.

Materials & Methods:

### 1. Equipment List:

1.1. 40 g/hr. Mobile zone Ozone Generator with Injection Pump Skid

1.2. Hand Held Ozone Monitor

1.3. Poultry parts Conveyor as supplied by the plant.

2. Consumable List supplied by the plant.

2.1. 15″×20″ sterile plastic bag (poultry rinse bag)

2.2. Sterile gloves

2.3. Buffered Peptone Water (BPW)—400 milliliters (ml)

2.5. Ice

2.6. Wheeled ice chest for shipping

2.7. Fresh raw Chicken Breasts

3. Microbial analysis of raw poultry product at third-party laboratory:

3.1. Aerobic Plate Count (APC) Petrifilm,

4. Ozone generation:

4.1. The Ozone Generator is powered and the settings on the mobile zone screen should be set to ozone production to 0%.

4.2. Once the Start Button is pressed. The Compressor and oxygen concentrator will start to run.

4.3. Once the Oxygen runs for 120 seconds, then change the ozone production setting to 100%. Ozone will be then be generated.

4.2. Ozone will be set to 0% output between samples.

4.4. Monitor ambient ozone levels at intervals as measured by the ambient ozone monitor to determine that the ambient ozone levels are within OSHA limits.

### 5. Additional Measurements for Experiment:

5.1. PAA levels

6. Ozone Testing Procedure: A conveyor is tented with plastic sheeting to contain the ozone gas. A fan and destruct unit will be connected to keep negative pressure in the chamber and prevent the ozone gas from escaping into the work area. The chicken breast will be transferred from the debone line before bone inspection and placed on the conveyor. The conveyor speed will be set to vary the exposure time from 5 seconds and 15 seconds. PAA will be applied before ozone on one sample set and after ozone on an additional sample set. Sample size will be 6 breasts, for each contact time.

6.1 Each breast will be placed in a sterile rinse bag,

6.2 400 ml of BPW will be added, shaken for one minute,

6.3 100 ml of rinsate will be poured into the sample cup,

6.4 Sample cup will be placed in cooler on top of cardboard and ice packs.

1. Experimental Design:
To determine the effect of ozone gas on poultry breast meat, the follow 8 treatment groups were tested (Appendix A),
   Group 1—Control group with no treatment to assess microbial counts
   Group 2—Conveyor speed set to 5 second exposure, no PAA
   Group 3—Conveyor speed set to 15 second exposure, No PAA
   Group 4—Conveyor speed set to 5 second exposure, PAA before Ozone
   Group 5—Conveyor speed set to 15 second exposure, PAA before Ozone
   Group 6—Conveyor speed set to 5 second exposure, PAA after Ozone
   Group 7—Conveyor speed set to 15 second exposure. PAA after Ozone
   Group 8—Conveyor speed set to 5 second exposure, no PAA, with nozzle

APPENDIX A
Control and Treatment Groups

| | Name of | | | Sample |
|---|---|---|---|---|
| Groups | Group | Treatment | Time of treatment | Numbers |
| Group 1 | Treatment- | None | None | A1-A6 |
| | A Control | | | |
| Group 2 | Treatment- B | No PAA | 5 seconds dwell time | B1-B6 |
| Group 3 | Treatment- C | No PAA | 15 seconds dwell time | C1-C6 |
| Group 4 | Treatment-D | PAA Before | 5 seconds dwell time | D1-D6 |
| Group 5 | Treatment-E | PAA Before | 15 seconds dwell time | E1-E6 |
| Group 6 | Treatment-F | PAA After | 5 seconds dwell time | F1-F6 |
| Group 7 | Treatment-G | PAA After | 15 seconds dwell time | G1-G6 |
| Group 8 | Treatment-H | No PAA | 5 seconds dwell time | H1-H6 |
| | | | With nozzles | |

2. Statistical Analysis

Statistical analysis is performed using SAS. A Student's T-test will be utilized to separate the means for all quantitative data in determination of statistical significance. The results will be made available to Ozone Solutions as soon as they are available.

3. Results & Discussion

Treatment

| | | | Log | Average |
|---|---|---|---|---|
| | | APC | Reduction | APC |
| | | Logl0 | from Control | Counts |
| A | Control - NoTreatment | 3.78 | | 6060 |
| B | 5 sec contact, no PAA | 2.85 | 0.93 | 708 |
| C | 15 sec contact, no PAA | 3.48 | 0.31 | 3000 |
| D | 5 sec contact, PAA before | 2.38 | 1.41 | 238 |
| E | 15 sec contact, PAA before | 2.11 | 1.68 | 128 |
| F | 5 sec contact, PAA after | 2.49 | 1.29 | 308 |
| G | 15 sec contact, PAA after | 2.37 | 1.41 | 234 |
| H | 5 sec contact, ozone nozzle | 3.51 | 0.28 | 3200 |

n = 5

Each sample consisted of 6 breasts weighing approximately 4 pounds. Samples were rinsed in BPW, put on ice and shipped overnight to a third-party lab.

Ozone nozzle for the treatment H was the same application as treatment B, except for the nozzles.

In this trial, the microbiological quality of Aerobic Plate Count ‘APC’, Enterobacteriaceae ‘EB’ and Salmonella Spp. of poultry parts was treated with gaseous ozone and compared to microbiological levels of poultry parts prior to any antimicrobial treatments. Seven treatment groups were included in this trial and include:
Ozone gas @ 5 seconds,
Ozone gas @ 1 5 seconds
PAA spray followed by ozone gas @ 5 seconds
PAA spray followed by ozone gas @ 15 seconds
Ozone gas followed by PAA spray for 5 seconds
Ozone gas followed by PAA spray for 15 seconds
Ozone gas forced through a small aperture fan nozzle for 5 seconds.

### Results and Discussion

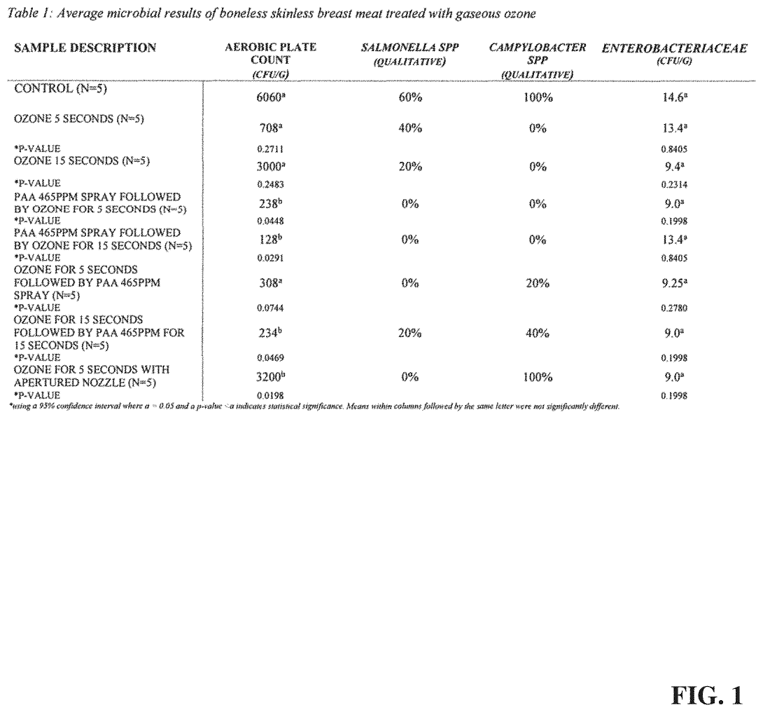

The samples were sent to the facility laboratory for microbial analysis of Aerobic Plate Counts ‘APC’, Salmonella Spp., Campylobacter Spp., and Enterobacteriaceae ‘EB’. Quantitative results were transformed into colony forming units per gram (CFU/g). Microbial analysis results for each part were then averaged among control and treated groups (Table 1/FIG. 1). A Students T-Test was utilized to separate the means for the quantitative data to determine the statistical significance of the microbial results. As summarized in Table 1, boneless skinless breast meat receiving no antimicrobial treatment resulted in an Aerobic Plate Count of 6060 CFU/g, a 60% prevalence rate of Salmonella Spp., 100% prevalence rate of Campylobacter Spp., and a Enterobacteriaceae level of 14.6 CFU/g. When an antimicrobial treatment of gaseous ozone was applied for approximately 5 seconds to both sides of the substrate, the result was an APC level of 708 CFU/g or an 88.3% reduction in counts while the quantitative amount of Enterobacteriaceae was reduced to 13.4 CFU/g which represents an 8.2% reduction from control. Salmonella and Campylobacter organisms were reduced to levels of 40% and none detectable respectively. When the substrate was exposed to a 15 second treatment of gaseous ozone, the corresponding APC and EB levels were reduced to 3000 CFU/g and 9.4 CFU/g respectively or a 50.5% and 35.6% reduction while Salmonella was reduced to an incidence level of 20% and no Campylobacter was detected. When the addition of a per acetic acid spray was introduced on the top surface of the product prior to a 5 second application of ozone gas, the levels of APC and EB were reduced to 238 CFU/g and 9 CFU/g respectively. This represents a 96% and 38.3% reduction from control. There were no findings of either Salmonella or Campylobacter on the product tested for this treatment group. When the peracetic acid was applied prior to a 15 second ozone gas treatment, the APC and EB counts were reduced to 128 CFU/g and 13.4 CFU/g respectively or by 97 0.8% and 8.2% whereas there were no findings of either Salmonella or Campylobacter on the product tested. When the peracetic acid was applied after a 5 second ozone gas treatment, the corresponding levels of APC and EB were 308 CFU/g and 9.25 CFU/g which is a 95% and 36.6% improvement from control while no presence of Campylobacter was detected and Salmonella prevalence was reduced to 20%. The effect of expanding the dwell time of the ozone gas to 15 seconds coupled by a spray of peracetic acid resulted in a APC and EB counts of 234 CFU/g and 9 CFU/g accordingly. This translates into a reduction in APC of 96.1% and a 38.3% reduction in Enterobacteriaceae. The incidence of Salmonella and Campylobacter in this treatment group was 40% and 20% respectively. The inclusion of a specifically designed nozzle to isolate the ozone gas as a direct product contact on the surface of the product did reduce Aerobic Plate Count to 3200 CFU/g and Enterobacteriaceae counts to 9 CFU/g. Comparatively this represents a 47.2% and 38.3% improvement in APC and EB levels when compared to non-treatment. There was no corresponding reduction in Campylobacter;

In conclusion, gaseous ozone as a single point intervention was able to reduce bacteriological counts on further processed boneless skinless breast meat. When a spray application of peracetic acid was introduced either before or after the ozone treatment, the reduced microbiological counts were statistically significant. From a pathogen performance standpoint, ozone gas did lower pathogen levels on the product for all treatment groups and combinations except for the nozzle treatment which failed to reduce Campylobacter prevalence. When time was increased for the application of ozone gas on the surface of the product, the microbiological results failed to decrease in linear fashion. It can be determined that a 5 second application time would be sufficient to maximize the efficiency of microbial reductions with ozone gas. When comparing the nozzle application of ozone gas to an ambient distribution of ozone gas, the nozzle set-up failed to significantly demonstrate better results than the ambient distribution method.

Although the disclosure has been described with reference to preferred embodiments, persons skilled in the art will recognize that changes may be made in form and detail without departing from the spirit and scope of the disclosed apparatus, systems and methods.

What is claimed is:

1. A method for disinfecting a meat product comprising:
a. placing the meat in a contacting chamber; and
b. directly contacting the meat with gaseous ozone for a time interval, wherein the time interval is sufficient to substantially reduce pathogens on the meat.

2. The method of claim 1, wherein the time interval is from about 3 seconds to about 30 seconds.

3. The method of claim 2, wherein the time interval is from about 5 seconds to about 15 seconds.

4. The method of claim 3, wherein the time interval is about 5 seconds.

5. The method of claim 1 wherein the gaseous ozone is introduced into the chamber at about 10 liters per minute.

6. The method of claim 5, wherein the gaseous ozone is comprised of from about 6% to about 8% ozone.

7. The method of claim 1, wherein there is negative pressure in the contacting chamber.

8. The method of claim 1, further comprising treating the meat product with a liquid disinfectant, prior to introducing the meat product into the contacting chamber.

9. The method of claim 8, wherein the liquid disinfectant is peracetic acid (PAA).

10. The method of claim 1, wherein the meat product is chosen from poultry, beef, lamb, and pork.

11. The method of claim 10, wherein the meat product is poultry.

12. The method of claim 11, wherein the poultry is chicken.

13. A method for disinfecting a meat product comprising:
a. placing the meat in a contacting chamber, the contacting chamber having a negative pressure; and
b. directly contacting the meat with gaseous ozone for a time interval, wherein the gaseous ozone is comprised of from about 6% to about 8% ozone and wherein the time interval is sufficient to substantially reduce pathogens on the meat.

14. The method of claim 13, wherein the time interval is from about 3 seconds to about 30 seconds.

15. The method of claim 14, wherein the time interval is from about 5 seconds to about 15 seconds.

16. The method of claim 15, wherein the time interval is about 5 seconds.

17. The method of claim 13, further comprising treating the meat product with a liquid disinfectant, prior to introducing the meat product into the contacting chamber.

18. The method of claim 17, wherein the liquid disinfectant is PAA.

19. A method for disinfecting a meat product comprising:
a. treating the meat product with a liquid disinfectant;
b. placing the meat in a contacting chamber, the contacting chamber having a negative pressure; and
c. directly contacting the meat with gaseous ozone at a rate about 10 liters per minute for a time interval, wherein the gaseous ozone is comprised of from about 6% to about 8% ozone and wherein the time interval is sufficient to substantially reduce pathogens on the meat.

20. The method of claim 19, wherein the liquid disinfectant is PAA.
